(19) United States
(12) Patent Application Publication
(10) Pub. No.: US 2025/0374296 A1
(43) Pub. Date: Dec. 4, 2025

(54) METHOD AND DEVICE FOR RESOURCE ALLOCATION IN WIRELESS COMMUNICATION SYSTEM

(71) Applicant: Samsung Electronics Co., Ltd., Suwon-si (KR)

(72) Inventors: Ikbeom LEE, Suwon-si (KR); Hojun KIM, Suwon-si (KR); Hayoung YANG, Suwon-si (KR)

(21) Appl. No.: 19/295,132

(22) Filed: Aug. 8, 2025

Related U.S. Application Data
(63) Continuation of application No. PCT/KR2023/016527, filed on Oct. 24, 2023.

(30) Foreign Application Priority Data
Feb. 8, 2023 (KR) 10-2023-0016719

(51) Int. Cl. H04W 72/232; H04L 1/00; H04W 72/1263

(52) U.S. Cl. CPC H04W 72/232; H04L 1/0003; H04W 72/1263

(57) ABSTRACT

A method and a device for resource allocation in a wireless communication system are provided. The method performed by a base station in a wireless communication system includes transmitting, to a terminal, configuration information including information on at least one first resource region to which at least one of a first channel and a first signal is allocated, transmitting, to the terminal, at least one piece of downlink control information (DCI) for scheduling transmission of a second channel, and receiving the second channel from the terminal, wherein the second channel is scheduled to overlap with the at least one first resource region and a second resource region corresponding to resources other than the first resource region.

### CROSS-REFERENCE TO RELATED APPLICATION(S)

This application is a continuation application, claiming priority under 35 U.S.C. § 365 (c), of an International application No. PCT/KR2023/016527, filed on Oct. 24, 2023, which is based on and claims the benefit of a Korean patent application number 10-2023-0016719, filed on Feb. 8, 2023, in the Korean Intellectual Property Office, the disclosure of which is incorporated by reference herein in its entirety.

### BACKGROUND

### 1. Field

The disclosure relates to a method and a device for resource allocation in a wireless communication system.

### 2. Description of Related Art

Fifth generation (5G) mobile communication technologies define broad frequency bands to enable high transmission rates and new services, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

5G mobile communication technology has been developed with the aim of supporting services and satisfying performance requirements for enhanced mobile broadband (eMBB), ultra-reliable low-latency communications (URLLC), and massive machine-type communications (mMTC). Currently, discussions are underway to improve and enhance the initial 5G mobile communication technology based on the services that 5G mobile communication technology was intended to support. In addition, discussions are also underway regarding technologies related to wireless interface architecture/protocols and system architecture/service areas to support new services through integration and convergence with other industries.

The development of these 5G mobile communication systems may serve as the foundation for the development of 6G mobile communication technology.

A base station allocates wireless resources to a terminal and performs communication with the terminal by using the allocated wireless resources. In order to increase channel capacity in a wireless communication system, there is a method of allocating more wireless resources. However, since wireless resources are limited, more efficient utilization of wireless resources is required.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a device for resource allocation in a wireless communication system.

Additional aspects will be set forth in part in the description which follows and, in part, will be apparent from the description, or may be learned by practice of the presented embodiments.

In accordance with an aspect of the disclosure, a method performed by a base station in a wireless communication system is provided. The method includes transmitting, to a terminal, configuration information including information on at least one first resource region to which at least one of a first channel and a first signal is allocated, transmitting, to the terminal, at least one piece of downlink control information (DCI) for scheduling transmission of a second channel, and receiving the second channel from the terminal, wherein the second channel is scheduled to overlap with the at least one first resource region and a second resource region corresponding to resources other than the first resource region.

In accordance with another aspect of the disclosure, a method performed by a terminal in a wireless communication system is provided. The method includes receiving, from a base station, configuration information including information on at least one first resource region to which at least one of a first channel and a first signal is allocated, receiving, from the base station, at least one piece of downlink control information (DCI) for scheduling transmission of a second channel, and transmitting the second channel to the base station, wherein the second channel is scheduled to overlap with the at least one first resource region and a second resource region corresponding to resources other than the first resource region.

In accordance with another aspect of the disclosure, a base station in a wireless communication system is provided. The base station includes a transceiver, memory, including one or more storage media, storing instructions, and at least one processor communicatively coupled to the transceiver and the memory, wherein the instructions, when executed by the at least one processor individually or collectively, cause the at least one processor to transmit, to a terminal, configuration information including information on at least one first resource region to which at least one of a first channel and a first signal is allocated, transmit, to the terminal, at least one piece of downlink control information (DCI) for scheduling transmission of a second channel, and receive the second channel from the terminal, wherein the second channel is scheduled to overlap with the at least one first resource region and a second resource region corresponding to resources other than the first resource region.

In accordance with another aspect of the disclosure, a terminal in a wireless communication system is provided. The terminal includes a transceiver, memory, including one or more storage media, storing instructions, and at least one processor communicatively coupled to the transceiver and the memory, wherein the instructions, when executed by the at least one processor individually or collectively, cause the at least one processor to receive, from a base station, configuration information including information on at least one first resource region to which at least one of a first channel and a first signal is allocated, receive, from the base station, at least one piece of downlink control information (DCI) for scheduling transmission of a second channel, and transmit the second channel to the base station, wherein the second channel is scheduled to overlap with the at least one first resource region and a second resource region corresponding to resources other than the first resource region.

In accordance with another aspect of the disclosure, one or more non-transitory computer-readable storage media storing one or more computer programs including computer-executable instructions that, when executed by one or more processors of a base station in a wireless communication system individually or collectively, cause the base station to perform operations are provided. The operations include transmitting, to a terminal, configuration information including information on at least one first resource region to which at least one of a first channel and a first signal is allocated, transmitting, to the terminal, at least one piece of downlink control information (DCI) for scheduling transmission of a second channel, and receiving the second channel from the terminal, wherein the second channel is scheduled to overlap with the at least one first resource region and a second resource region corresponding to resources other than the first resource region.

According to the disclosure, wireless communication can be performed efficiently.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of a control resource set (CORESET) used to transmit a downlink control channel in a wireless communication system according to an embodiment of the disclosure;

FIG. 4 illustrates a structure of a downlink control channel in a wireless communication system according to an embodiment of the disclosure;

FIG. 5 illustrates a non-overlapping resource allocation method according to an embodiment of the disclosure;

FIG. 6 illustrates an overlapping resource allocation method according to an embodiment of the disclosure;

FIG. 7 illustrates a method of allocating one transport block (TB) to one user equipment (UE) in an overlapping resource allocation method according to an embodiment of the disclosure;

FIG. 8 illustrates a method of allocating, in a single slot, multiple TBs to multiple UEs in an overlapping resource allocation method according to an embodiment of the disclosure;

FIG. 9 illustrates a method of allocating, in a single slot, multiple TBs to one UE in an overlapping resource allocation method according to an embodiment of the disclosure;

FIG. 10 is a flowchart illustrating a resource allocation method by a base station according to an embodiment of the disclosure;

FIG. 11 is a flowchart illustrating a resource allocation method by a UE according to an embodiment of the disclosure;

FIG. 12 is a block diagram illustrating an internal structure of a UE according to an embodiment of the disclosure; and

FIG. 13 is a block diagram illustrating a structure of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, the base station and the terminal are not limited to the above examples. In the disclosure, a “downlink (DL)” refers to a radio link via which a base station transmits a signal to a terminal, and an “uplink (UL)” refers to a radio link via which a terminal transmits a signal to a base station.

In the following description of the disclosure, terms and names defined in 5G system (5GS) and new radio (NR) standards, which are the standards specified by the 3^{rd} generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5th generation mobile communication standards (5GS/NR).

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

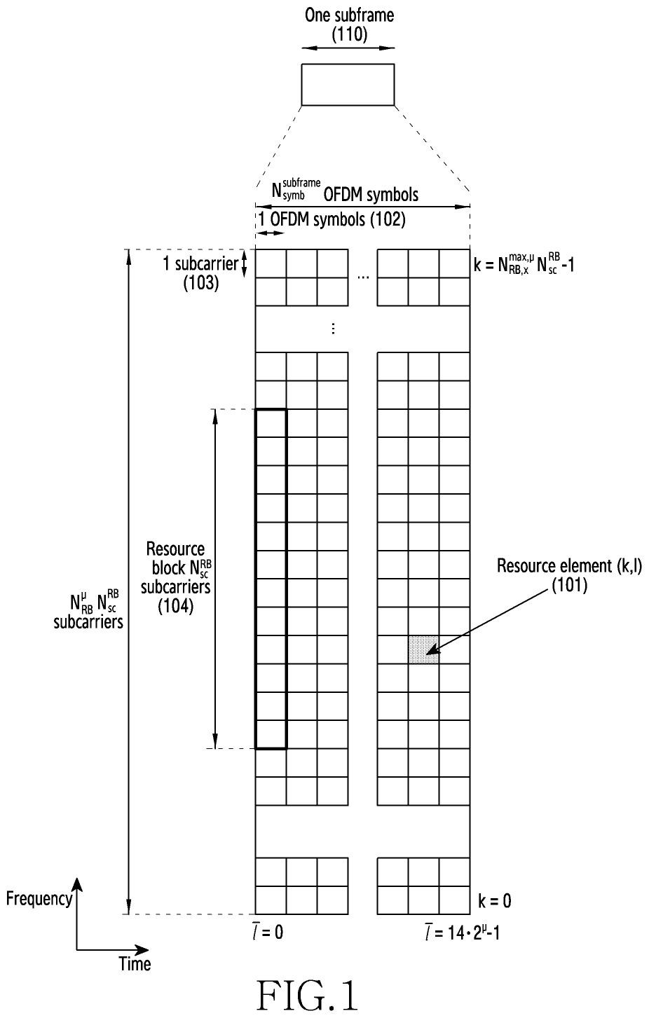

FIG. 1 illustrates a basic structure of a time-frequency domain in a wireless communication system according to an embodiment of the disclosure.

Referring to FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB}. (for example, 12) consecutive REs may constitute one resource block (RB) 104. In the time domain, one subframe 110 may include multiple OFDM symbols 102. For example, the length of one subframe may be 1 ms.

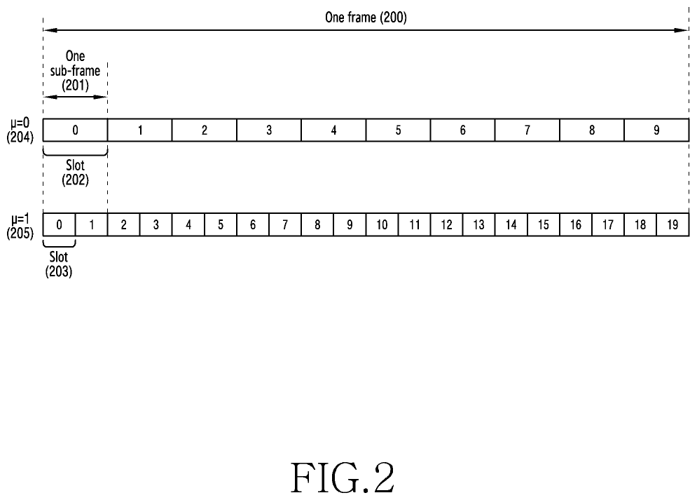

FIG. 2 illustrates a structure of a frame, a subframe, and a slot in a wireless communication system according to an embodiment of the disclosure.

Referring to FIG. 2, an example of a structure of a frame 200, a subframe 201, and a slot 202 is illustrated. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot

$${N}_{symb}^{slot} = 14 ) .$$

One subframe 201 may include one or multiple slots 202 and 203, and the number of slots 202 and 203 per one subframe 201 may vary depending on configuration values u for the subcarrier spacing 204 or 205. The example in FIG. 2 illustrates a case in which the subcarrier spacing configuration value is μ=0 204, and a case in which μ=1 205. In the case of μ=0 204, one subframe 201 may include one slot 202, and in the case of μ=1 205, one subframe 201 may include two slots 203. For example, the number of slots per one subframe

$${N}_{slot}^{subframe , μ}$$

may differ depending on the subcarrier spacing configuration value μ, and the number of slots per one frame

$${N}_{slot}^{frame , μ}$$

may differ accordingly.

$${N}_{slot}^{subframe , μ} and {N}_{slot}^{frame , μ}$$

may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Hereinafter, a downlink control channel in a 5G communication system will be described in more detail with reference to the accompanying drawings.

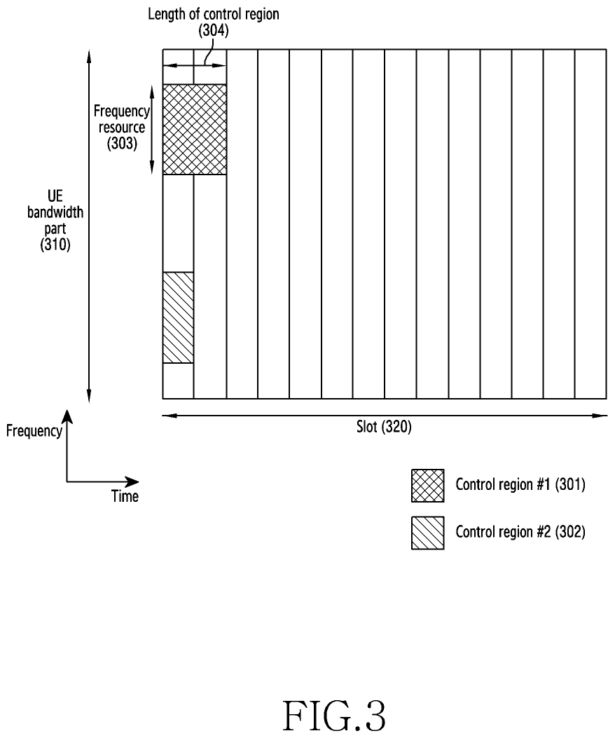

FIG. 3 illustrates an example of a control resource set (CORESET) used to transmit a downlink control channel in a wireless communication system according to an embodiment of the disclosure.

FIG. 3 illustrates an example in which a UE bandwidth part 310 is configured along the frequency axis, and two control resource sets (control resource set #1 301 and control resource set #2 302) are configured within one slot 320 along the time axis. The control resource sets 301 and 302 may be configured in a specific frequency resource 303 within the entire UE bandwidth part 310 along the frequency axis. The control resource sets 301 and 302 may be each configured as one or multiple OFDM symbols along the time domain, and the number of the OFDM symbols may be defined as a control resource set duration 304. Referring to the example illustrated in FIG. 3, control resource set #1 301 is configured to have a control resource set duration corresponding to two symbols, and control resource set #2 302 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information, such as a control resource set identity, the control resource set's frequency location, and the control resource set's symbol duration is provided.

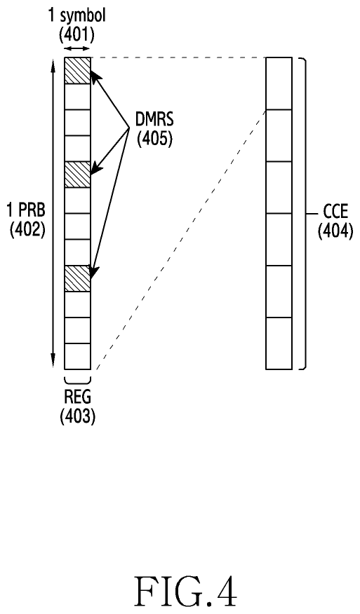

FIG. 4 illustrates a structure of a downlink control channel in a wireless communication system according to an embodiment of the disclosure.

Referring to FIG. 4, FIG. 4 illustrates an example of a basic unit of time and frequency resources constituting a downlink control channel. According to FIG. 4, the basic unit of time and frequency resources constituting a control channel may be referred to as a resource element group (REG) 403, and the REG 403 may be defined by one OFDM symbol 401 along the time axis and one physical resource block (PRB) 402, that is, 12 subcarriers, along the frequency axis. The base station may configure a downlink control channel allocation unit by concatenating the REGs 403.

Provided that the basic unit of downlink control channel allocation in 5G is a control channel element (CCE) 404 as illustrated in FIG. 4, one CCE 404 may include multiple REGs 403. To describe the REG 403 illustrated in FIG. 4, for example, the REG 403 may include 12 REs, and if one CCE 404 includes six REGs 403, one CCE 404 may then include 72 REs. A downlink control resource set, once configured, may include multiple CCEs 404, and a specific downlink control channel may be mapped to one or multiple CCEs 404 and then transmitted according to the aggregation level (AL) in the control resource set. The CCEs 404 in the control resource set are distinguished by numbers, and the numbers of CCEs 404 may be allocated according to a logical mapping scheme.

The basic unit of the downlink control channel illustrated in FIG. 4, that is, the REG 403, may include both REs to which DCI is mapped, and an area to which a demodulation reference signal (DMRS % n) for decoding the same is mapped. As in FIG. 4, three DMRSs may be transmitted inside one REG 405. The number of CCEs necessary to transmit a physical downlink control channel (PDCCH) may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information, such as dynamic scheduling regarding system information or a paging message. For example, physical downlink shared channel (PDSCH) scheduling allocation information for transmitting a system information block (SIB) including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or physical uplink shared channel (PUSCH) may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations, such as the number of PDCCH candidates at each aggregation level L, the monitoring cycle regarding the search space, the monitoring occasion with regard to each symbol in a slot regarding the search space, the search space type (common search space or UE-specific search space), a combination of a radio network temporary identifier (RNTI) and a DCI format to be monitored in the corresponding search space, a control resource set index for monitoring the search space, and the like.

According to configuration information, the base station may configure one or multiple search space sets for the UE. According to some embodiments of the disclosure, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting.
DCI format 0_0/1_0 with CRC scrambled by C-RNTI, configured scheduling RNTI (CS-RNTI), semi-persistent channel state information RNTI (SP-CSI-RNTI), random access RNTI (RA-RNTI), temporary cell RNTI (TC-RNTI), paging RNTI (P-RNTI), system information RNTI (SI-RNTI)
DCI format 2_0 with CRC scrambled by slot format indicator (SFI-RNTI)
DCI format 2_1 with CRC scrambled by Interruption RNTI (INT-RNTI)
DCI format 2_2 with CRC scrambled by transmit power control for PUSCH RNTI (TPC-PUSCH-RNTI), TPC-PUCCH-RNTI
DCI format 2_3 with CRC scrambled by transmit power control for sounding reference signal RNTI (TPC-SRS-RNTI)

Combinations of DCI formats and RNTIs given below may be monitored in a UE-specific search space. Obviously, the examples given below are not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below.
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS

The DCI formats enumerated above may follow the definitions given below.

TABLE 2

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission |
| | is intended for the UE |
| 2_2 | Transmission of TPC commands for PUCCH and |
| | PUSCH |
| 2_3 | Transmission of a group of TPC commands for SRS |
| | transmissions by one or more UEs |

In 5G, multiple search space sets may be configured by different parameters (for example, parameters in Table 2), and the group of search space sets monitored by the UE at each time point may differ accordingly. For example, if search space set #1 is configured at X-slot periodicity, if search space set #2 is configured at Y-slot periodicity, and if X and Y are different, the UE may monitor search space set #1 and search space set #2 both in a specific slot, and may monitor one of search space set #1 and search space set #2 both in another specific slot.

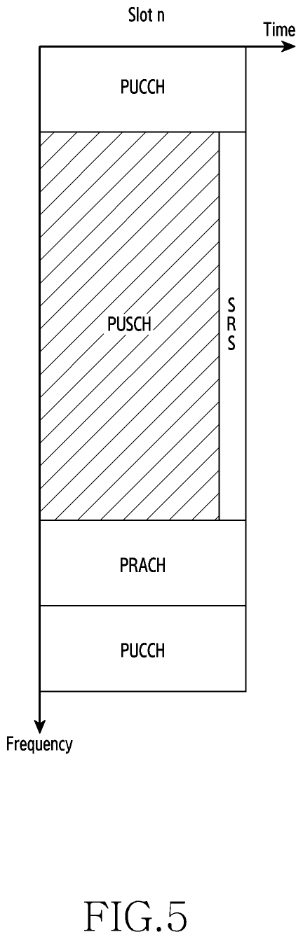

FIG. 5 illustrates a non-overlapping resource allocation method according to an embodiment of the disclosure.

Referring to FIG. 5, an uplink resource allocation structure according to an embodiment is illustrated. A base station may first allocate a control channel and/or a reference signal (RS) to a radio resource region, and then allocate a data channel (data channel or shared channel). In an embodiment of the disclosure, the control channel and/or the reference signal may include a physical uplink control channel (PUCCH), a sounding reference signal (SRS), a physical random access channel (PRACH), and the like. In addition, the data channel may include a physical uplink shared channel (PUSCH).

In an embodiment of the disclosure, the base station may, in the uplink, first allocate control channels and/or reference signals, such as PUCCH, SRS, and PRACH. In this case, the base station may allocate the PUCCH first, allocate the PRACH next, and then allocate the SRS. However, the method by which the base station allocates the control channel and/or reference signal is not limited thereto, and the base station may allocate the control channel and/or reference signal by using various methods.

Thereafter, the base station may allocate a data channel, such as a PUSCH, to a radio resource region to which a control channel and/or a reference signal, such as PUCCH, SRS, and PRACH is not allocated. For example, as illustrated in FIG. 5, the control channel and/or the reference signal and the data channel do not overlap and may be allocated to each of the radio resource regions. In the disclosure, such a resource allocation method is referred to as a non-overlapping resource allocation method. However, the method in which the control channel and/or the reference signal and the data channel are allocated to respective radio resource regions without overlapping is not limited thereto and may be referred to by various terms.

According to an embodiment of the disclosure, the non-overlapping resource allocation method ensures that the control channel and/or reference signal and the data channel are allocated to respective radio resource regions without overlapping, thereby enabling the base station and UE to clearly understand how specific resource regions are being used. Accordingly, in communication between the base station and the UE, there is an effect of simplifying signaling and reducing the possibility of errors. However, since the control channel and/or the reference signal and the data channel allocated to each resource region are clearly defined, the resource region cannot be utilized even when there is no channel and/or signal to be transmitted in a specific resource region, which may reduce flexibility. For example, even when a control channel and/or a reference signal, such as PUCCH, PRACH, and SRS are not transmitted, the radio resource region allocated to the control channel and/or the reference signal, such as PUCCH, PRACH, and SRS cannot be used to transmit the data channel, such as a PUSCH, which make it difficult to use resources efficiently.

Furthermore, although the uplink has been described as an example in FIG. 5, the embodiments of the disclosure are not limited thereto, and the same method can be applied to the downlink as well. For example, a control channel and/or a reference signals, such as a physical downlink control channel (PDCCH), a channel state information reference signal (CSI-RS), a demodulation reference signal (DMRS), and a phase tracking reference signal (PTRS), and a data channel, such as a physical downlink shared channel (PDSCH) do not overlap and can be allocated to respective radio resource regions.

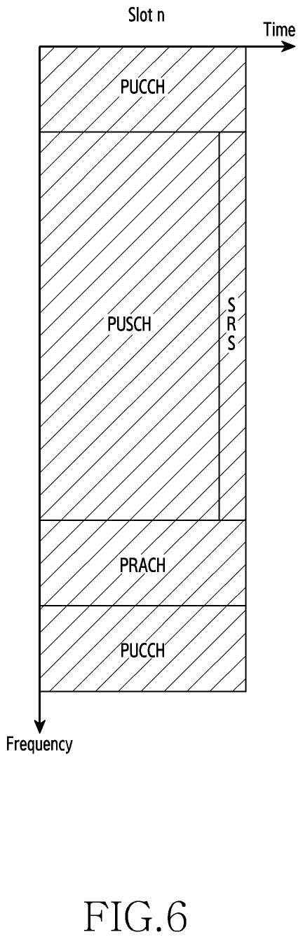

FIG. 6 illustrates an overlapping resource allocation method according to an embodiment of the disclosure.

Referring to FIG. 6, an uplink resource allocation structure according to an embodiment is illustrated. A base station may first allocate a control channel and/or a reference signal to a radio resource region, and then allocate a data channel. In an embodiment of the disclosure, the control channel and/or the reference signal may include a PUCCH, an SRS, a PRACH, and the like. In addition, the data channel may include a PUSCH.

In an embodiment of the disclosure, the base station may first allocate control channels and/or reference signals, such as PUCCH, SRS, and PRACH, in the uplink. Here, the base station may allocate the PUCCH first, allocate the PRACH next, and then allocate the SRS. However, the method by which the base station allocates the control channel and/or reference signal is not limited thereto, and the base station may allocate the control channel and/or reference signal by using various methods.

Thereafter, the base station may allocate a data channel, such as a PUSCH, to the entire radio resource region including the radio resource region to which the control channel and/or the reference signal, such as a PUCCH, an SRS, a PRACH, or the like, is allocated. For example, as illustrated in FIG. 6, the resource region to which the control channel and/or the reference signal is allocated and the resource region to which the data channel is allocated may overlap. In the disclosure, such a resource allocation method is referred to as an overlapping resource allocation method. However, the method in which the resource region to which the control channel and/or the reference signal is allocated and the resource region to which the data channel is allocated overlap is not limited thereto and may be referred to by various terms.

According to an embodiment of the disclosure, in the overlapping resource allocation method, a control channel and/or a reference signal and a data channel are allocated in an overlapping manner to radio resource regions, allowing the base station and the UE to efficiently use radio resources for communication. For example, when the control channel and/or the reference signal, such as PUCCH, PRACH, and SRS are not transmitted, the radio resource region allocated to the control channel and/or the reference signal, such as PUCCH, PRACH, and SRS may not be used for transmission of the data channel, such as a PUSCH, so that the resource can be flexibly and dynamically used. Accordingly, efficient use of resources is possible.

Furthermore, although the uplink is described as an example in FIG. 6, the disclosure is not limited thereto, and the same method can be applied to the downlink. For example, a resource region to which control channels and/or reference signals, such as a physical downlink control channel (PDCCH), a channel state information reference signal (CSI-RS), a demodulation reference signal (DMRS), and a phase tracking reference signal (PTRS), are allocated, and a resource region to which a data channel, such as a physical downlink shared channel (PDSCH), is allocated may overlap.

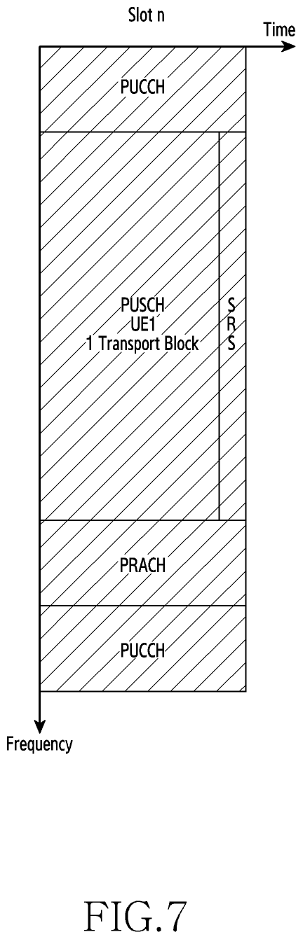

FIG. 7 illustrates a method of allocating one transport block (TB) to one UE in an overlapping resource allocation method according to an embodiment of the disclosure.

In explaining FIG. 7, duplicates of those described above will be briefly explained or omitted.

Referring to FIG. 7, an uplink resource allocation structure according to an embodiment is illustrated. A base station may first allocate a control channel and/or a reference signal to a radio resource region, and then allocate a data channel. For example, as illustrated in FIG. 7, a resource region to which a control channel and/or a reference signal is allocated and a resource region to which a data channel is allocated may overlap. In an embodiment of the disclosure, the control channel and/or the reference signal may include a PUCCH, an SRS, a PRACH, or the like. In addition, the data channel may include a PUSCH.

In an embodiment of the disclosure, a base station may allocate, in a single slot, to one UE (UE1), all or a part of a resource region to which a control channel and/or a reference signal is allocated and a resource region to which a data channel is allocated. In this case, the base station may, in a single slot, allocate one transport block (TB) to all or a part of the resource regions. For example, as illustrated in FIG. 7, the base station may allocate, using one TB, the resource regions allocated to the PUCCH (upper), PUSCH, SRS, PRACH, and PUCCH (lower) to one UE. In other words, the size of the TB may correspond to the size of the entire resource region in a single slot in a bandwidth or bandwidth part. In addition, the base station may allocate, using one TB, a portion of the resource regions allocated to the PUCCH (upper), PUSCH, SRS, PRACH, and PUCCH (lower), for example, the resource regions allocated to the PUCCH (upper), PUSCH, PRACH, and PUCCH (lower), to one UE. However, the disclosure is not limited thereto, and the data channel may also be allocated to a resource region to which at least one control channel and/or reference signal is allocated.

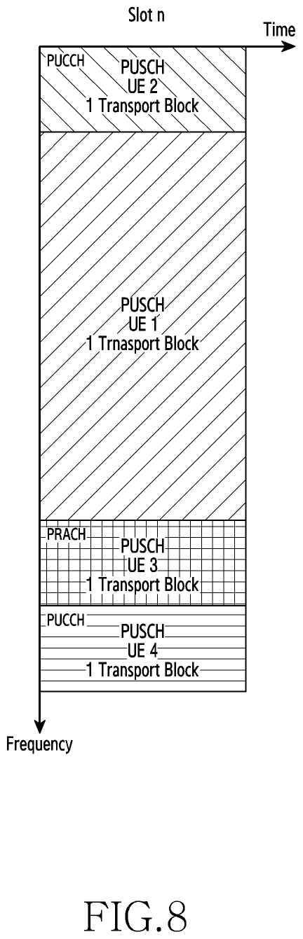

FIG. 8 illustrates a method of allocating, in a single slot, multiple TBs to multiple UEs in an overlapping resource allocation method according to an embodiment of the disclosure.

In explaining FIG. 8, duplicates of those described above will be briefly explained or omitted.

Referring to FIG. 8, an uplink resource allocation structure according to an embodiment is illustrated. A base station may first allocate a control channel and/or a reference signal to a radio resource region, and then allocate a data channel. For example, as illustrated in FIG. 8, a resource region to which a control channel and/or a reference signal is allocated and a resource region to which a data channel is allocated may overlap. In an embodiment of the disclosure, the control channel and/or the reference signal may include a PUCCH, an SRS, a PRACH, or the like. In addition, the data channel may include a PUSCH.

In an embodiment of the disclosure, the base station may allocate, in a single slot, to multiple UEs, all or a part of a resource region to which a control channel and/or a reference signal is allocated and a resource region to which a data channel is allocated. In this case, the base station may allocate, in a single slot, one TB to each of UEs (Multi-UE 1 TB). Furthermore, a modulation and coding scheme (MCS) may be individually applied to each TB. More specifically, in a single slot, the data channels transmitted through the resource region to which a control channel and/or a reference signal is allocated and the resource region to which a data channel is allocated may each experience different channel conditions. Accordingly, an MCS suitable for the channel condition may be applied to each TB allocated to each resource region. According to an embodiment of the disclosure, communication may be performed more effectively by applying an MCS suitable for each channel condition in the transmission of the data channel.

For example, as illustrated in FIG. 8, the base station may allocate, in a single slot, the resource regions allocated to the PUCCH (upper), PUSCH, PRACH, and PUCCH (lower) to four UEs (UE1, UE2, UE3, and UE4), using one TB for each of the UEs. In this case, an MCS may be individually applied to each of the TBs allocated to the respective UEs (UE1, UE2, UE3, and UE4). For example, it is possible to apply different MCSs to the TBs allocated to the respective UEs (UE1, UE2, UE3, and UE4) in a single slot.

In addition, the base station may allocate, in a single slot, a portion of the resource regions allocated to the PUCCH (upper), PUSCH, PRACH, and PUCCH (lower), for example, the resource regions allocated to the PUCCH (upper), PUSCH, and PRACH to three UEs, using one TB for each of the UEs. However, the disclosure is not limited thereto, and a data channel may be allocated to at least one resource region to which a control channel and/or a reference signal is allocated. In this case, an MCS may be individually applied to each of the TBs allocated to the respective UEs.

Furthermore, the base station may allocate, in a single slot, the resource regions allocated to the PUCCH (upper), PUSCH, PRACH, and PUCCH (lower) to at least one UE. For example, the base station may allocate the resource regions allocated to the PUCCH (upper) and PUSCH to one UE, and allocate the resource regions allocated to PRACH and the PUCCH (lower) to two other UEs, respectively. In this case, the base station may allocate one TB to each of the UEs. Here, an MCS may be individually applied to the TBs allocated to the respective UEs.

In addition, in FIG. 8, a resource region allocated to the SRS is not illustrated in order to explain various embodiments. However, the disclosure is not limited thereto, and resources for the SRS may be allocated as shown in FIGS. 5, 6, and 7. Furthermore, the PUSCH may be allocated in an overlapping manner on the resource allocated to the SRS.

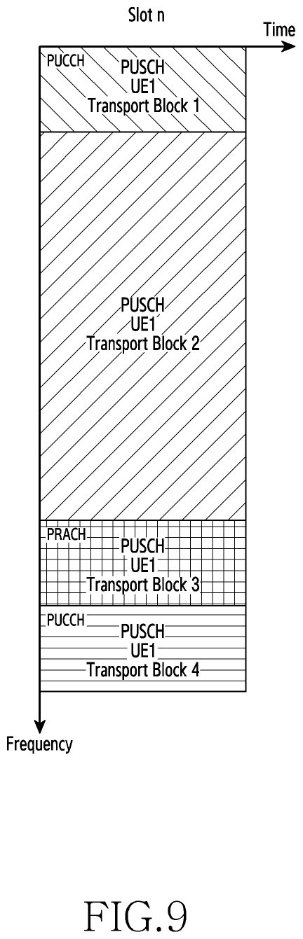

FIG. 9 illustrates a method of allocating, in a single slot, multiple TBs to one UE in an overlapping resource allocation method according to an embodiment of the disclosure.

In explaining FIG. 9, duplicates of those described above will be briefly explained or omitted.

Referring to FIG. 9, an uplink resource allocation structure according to an embodiment is illustrated. A base station may first allocate a control channel and/or a reference signal to a radio resource region, and then allocate a data channel. For example, as illustrated in FIG. 9, a resource region to which a control channel and/or a reference signal is allocated and a resource region to which a data channel is allocated may overlap. In an embodiment of the disclosure, the control channel and/or the reference signal may include a PUCCH, an SRS, a PRACH, or the like. In addition, the data channel may include a PUSCH.

In an embodiment of the disclosure, the base station may allocate, in a single slot, to one UE, all or a part of the resource region to which the control channel and/or the reference signal is allocated and the resource region to which the data channel is allocated. In this case, the base station may allocate, in a single slot, one TB to each of the resource region to which the control channel and/or the reference signal is allocated and the resource region to which the data channel is allocated (1UE Multi-TB). Furthermore, an MCS may be individually applied to each TB. More specifically, in a single slot, the data channels transmitted through the resource region to which the control channel and/or the reference signal is allocated and the resource region to which the data channel is allocated may each experience different channel conditions. Therefore, an MCS suitable for the channel condition may be applied to each TB allocated to each of the resource regions. According to an embodiment of the disclosure, communication may be performed more effectively by applying an MCS suitable for each channel condition in the transmission of the data channel.

For example, as illustrated in FIG. 9, the base station may allocate, in a single slot, the resource regions allocated to the PUCCH (upper), PUSCH, PRACH, and PUCCH (lower) to one UE (UE1), using four different TBs. Here, MCS may be applied individually to the TBs allocated to the respective resource regions. For example, it is possible to apply different MCSs to each of the TBs allocated to the one UE (UE1) in a single slot.

In addition, the base station may allocate, in a single slot, a portion of the resource regions allocated to the PUCCH (upper), PUSCH, PRACH, and PUCCH (lower), for example, the resource regions allocated to the PUCCH (upper), PUSCH, and PRACH to one UE, using three different TBs. However, the disclosure is not limited thereto, and a data channel may be allocated to a resource region to which at least one control channel and/or reference signal is allocated. In this case, MCS may be applied individually to each of TBs.

In addition, in FIG. 9, a resource region allocated to the SRS is not illustrated in order to explain various embodiments. However, the disclosure is not limited thereto, and resources for the SRS may be allocated as shown in FIGS. 5, 6, and 7. Furthermore, the PUSCH may be allocated in an overlapping manner on the resource allocated to the SRS.

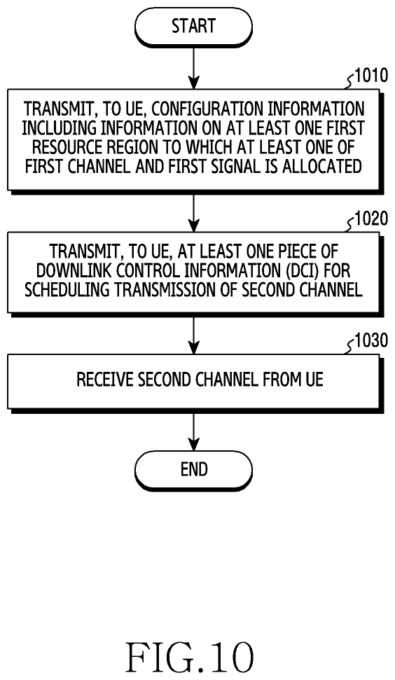

FIG. 10 is a flowchart illustrating a resource allocation method by a base station according to an embodiment of the disclosure.

In operation 1010, the base station transmits, to the UE, configuration information including information on at least one first resource region to which at least one of a first channel and a first signal is allocated. Here, the first channel and the first signal may include a control channel and/or a reference signal. For example, the control channel and/or the reference signal may include a PUCCH, an SRS, a PRACH, or the like.

In an embodiment of the disclosure, the base station may allocate the control channel and/or the reference signal, such as PUCCH, SRS, and PRACH, through configuration information in the uplink. Here, the base station may allocate the PUCCH first, allocate the PRACH next, and then allocate the SRS. However, the method by which the base station allocates the control channel and/or reference signal is not limited thereto, and the base station may allocate the control channel and/or reference signal through various methods.

In an embodiment of the disclosure, the configuration information may be transmitted via higher layer signaling, where the higher layer signaling may include radio resource control (RRC) signaling.

In operation 1020, the base station transmits, to the UE, at least one piece of downlink control information (DCI) for scheduling the transmission of a second channel. Here, the second channel may be scheduled while being overlapped with at least one first resource region and a second resource region, which is a remaining resource excluding the first resource region.

In an embodiment of the disclosure, at least one first resource region and a second resource region may be allocated at least one transport block (TB) in a single slot. Here, a modulation and coding scheme (MCS) may be individually applied to each TB. In a single slot, the data channels transmitted through a resource region to which a control channel and/or a reference signal is allocated and a resource region to which a data channel is allocated may each experience different channel conditions. Accordingly, an MCS suitable for the channel condition may be applied to each TB allocated to the respective resource regions. According to an embodiment of the disclosure, communication can be performed more effectively by applying an MCS suitable for each channel condition in data channel transmission.

In an embodiment of the disclosure, at least one TB in a single slot may be allocated to a UE. For example, the base station may allocate, in a single slot, to one UE, all or a part of a resource region to which a control channel and/or a reference signal is allocated and a resource region to which a data channel is allocated. In this case, the base station may allocate, in a single slot, one TB to each of the resource region to which each control channel and/or a reference signal is allocated and the resource region to which each data channel is allocated (1UE Multi-TB).

In an embodiment of the disclosure, each TB in a single slot may be allocated to a different UE. For example, the base station may allocate, in a single slot, to multiple UEs, all or a part of the resource region to which the control channel and/or the reference signal is allocated and the resource region to which the data channel is allocated. The base station may allocate, in a single slot, one TB to each of the respective UEs (Multi-UE 1 TB).

In an embodiment of the disclosure, the base station may transmit one piece of DCI for scheduling the transmission of a second channel with respect to both at least one first resource region and a second resource region. For example, the base station may schedule the entire resource region through one piece of DCI. In this case, the DCI may include at least one piece of identification information or indication information for identifying each of the at least one first resource region and the second resource region. For example, in order to distinguish between the resource region to which a control channel and/or a reference signal is allocated and the resource region to which a data channel is allocated, the resource regions to be scheduled through one piece of DCI, the base station may include, in the DCI, at least one piece of identification information or indication information for identifying and/or indicating each of resource regions, and transmit the DCI to the UE.

In an embodiment of the disclosure, the base station may transmit multiple pieces of DCI for scheduling the transmission of a second channel with respect to each of at least one first resource regions and a second resource region. For example, the base station may schedule each of the resource regions by using different pieces of DCI. Here, the DCI may include identification information or indication information for identifying the at least one first resource region and the second resource region. For example, in order to distinguish between the resource region to which a control channel and/or a reference signal is allocated and the resource region to which a data channel is allocated, the base station may include, in the DCI, identification information or indication information for identifying and/or indicating each of resource regions, and transmit the DCI to the UE.

Furthermore, in an embodiment of the disclosure, in order to individually apply MCS to each TB allocated to each resource region, the DCI may include MCS information corresponding to the identification information or indication information. Here, the MCS information may include an MCS index. The MCS index may include an index corresponding to at least one of a modulation method, a modulation order, a code rate, a target code rate, code rate information, a spectral efficiency, a transport block size (TBS) index, TB size information (TBS information), and a redundancy version.

When the base station transmits one piece of DCI for scheduling the transmission of a second channel with respect to both at least one first resource region and a second resource region, the DCI may include at least one piece of identification information or indication information, and may include at least one piece of MCS information corresponding thereto. Furthermore, when the base station transmits multiple pieces of DCI for scheduling the transmission of the second channel with respect to each of the at least one first resource region and the second resource region, the DCI may include identification information or indication information and at least one piece of MCS information corresponding thereto.

In operation 1030, the base station may receive a second channel from the UE. Here, the base station may receive the second channel from the UE, based on the DCI transmitted in operation 1020.

Although not illustrated in FIG. 10, the base station may receive uplink control information (UCI) from the UE with respect to both the at least one first resource region and the second resource region. In addition, the base station may receive the UCI from the UE with respect to each of the at least one first resource region and the second resource region. In an embodiment of the disclosure, the UCI is transmitted via a PUCCH, and may include acknowledgement/negative acknowledgement or not acknowledged (ACK/NACK), a scheduling request (SR), channel state information (CSI), or the like.

According to an embodiment of the disclosure, an overlapping resource allocation method enables the base station and the UE to perform communication by efficiently utilizing radio resources, as a control channel and/or a reference signal and a data channel are allocated to a radio resource region in an overlapping manner.

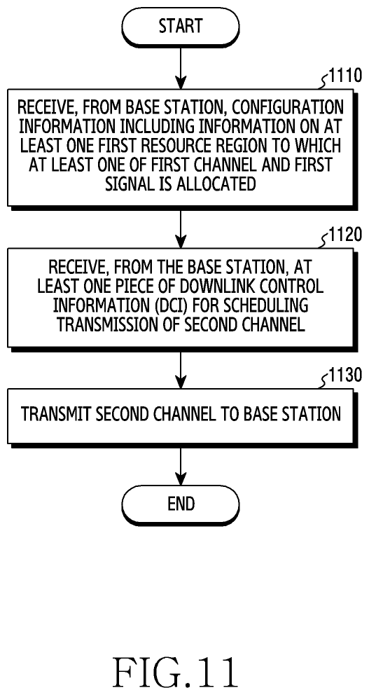

FIG. 11 is a flowchart illustrating a UE resource allocation method according to an embodiment of the disclosure.

In operation 1110, the UE receives, from the base station, configuration information including information on at least one first resource region to which at least one of a first channel and a first signal is allocated. Here, the first channel and the first signal may include a control channel and/or a reference signal. For example, the control channel and/or the reference signal may include a PUCCH, an SRS, a PRACH, or the like.

In an embodiment of the disclosure, in the uplink, the UE may receive allocation of a control channel and/or a reference signal, such as a PUCCH, an SRS, a PRACH, or the like, from the base station through configuration information. Here, the UE may receive allocation of the PUCCH first, followed by the PRACH, and then the SRS from the base station. However, the method by which the UE receives allocation of the control channel and/or the reference signal from the base station is not limited thereto, and the UE may receive allocation of the control channel and/or the reference signal through various methods.

In an embodiment of the disclosure, the configuration information may be transmitted via higher layer signaling, where the higher layer signaling may include radio resource control (RRC) signaling.

In operation 1120, the UE receives, from the base station, at least one piece of downlink control information (DCI) for scheduling the transmission of a second channel. Here, the second channel may be scheduled while being overlapped with at least one first resource region and a second resource region, which is a remaining resource excluding the first resource region.

In an embodiment of the disclosure, at least one first resource region and a second resource region may be allocated at least one transport block (TB) in a single slot. Here, a modulation and coding scheme (MCS) may be individually applied to each TB. In a single slot, the data channels transmitted through a resource region to which a control channel and/or a reference signal is allocated and a resource region to which a data channel is allocated may each experience different channel conditions. Accordingly, an MCS suitable for the channel condition may be applied to each TB allocated to the respective resource regions. According to an embodiment of the disclosure, communication can be performed more effectively by applying an MCS suitable for each channel condition in data channel transmission.

In an embodiment of the disclosure, at least one TB in a single slot may be allocated to a UE. For example, the base station may allocate, in a single slot, to one UE, all or a part of a resource region to which a control channel and/or a reference signal is allocated and a resource region to which a data channel is allocated. In this case, the UE may receive, from the base station, an allocation of one TB in a single slot with respect to each of the resource region to which each control channel and/or a reference signal is allocated and the resource region to which each data channel is allocated (1UE Multi-TB).

In an embodiment of the disclosure, each TB in a single slot may be allocated to a different UE. For example, the base station may allocate, in a single slot, to multiple UEs, all or a part of the resource region to which the control channel and/or the reference signal is allocated and the resource region to which the data channel is allocated. Each UE may receive, from the base station, an allocation of one TB in a single slot (Multi-UE 1 TB).

In an embodiment of the disclosure, the UE may receive, from the base station, one piece of DCI for scheduling the transmission of a second channel with respect to both at least one first resource region and a second resource region. For example, the UE may receive scheduling of the entire resource region through one piece of DCI. In this case, the DCI may include at least one piece of identification information or indication information for identifying each of the at least one first resource region and the second resource region. For example, in order to distinguish between the resource region to which a control channel and/or a reference signal is allocated and the resource region to which a data channel is allocated, the resource regions to be scheduled through one piece of DCI, the base station may include, in the DCI, at least one piece of identification information or indication information for identifying and/or indicating each of resource regions, and transmit the DCI to the UE.

In an embodiment of the disclosure, the UE may receive, from the base station, multiple pieces of DCI for scheduling the transmission of a second channel with respect to each of at least one first resource regions and a second resource region. For example, the UE may receive scheduling of each of the resource regions using different pieces of DCI. Here, the DCI may include identification information or indication information for identifying the at least one first resource region and the second resource region. That is, in order to distinguish between the resource region to which a control channel and/or a reference signal is allocated and the resource region to which a data channel is allocated, the base station may include, in the DCI, identification information or indication information for identifying and/or indicating each of resource regions, and transmit the DCI to the UE.

Furthermore, in an embodiment of the disclosure, in order to individually apply MCS to each TB allocated to each resource region, the DCI may include MCS information corresponding to the identification information or indication information. Here, the MCS information may include an MCS index. The MCS index may include an index corresponding to at least one of a modulation method, a modulation order, a code rate, a target code rate, code rate information, a spectral efficiency, a transport block size (TBS) index, TB size information (TBS information), and a redundancy version.

When the UE receives, from the base station, one piece of DCI for scheduling the transmission of a second channel with respect to both at least one first resource region and a second resource region, the DCI may include at least one piece of identification information or indication information, and may include at least one piece of MCS information corresponding thereto. Furthermore, when UE receives, from the base station, multiple pieces of DCI for scheduling the transmission of the second channel with respect to each of the at least one first resource region and the second resource region, the DCI may include identification information or indication information and at least one piece of MCS information corresponding thereto.

In operation 1130, the UE transmits the second channel to the base station. Here, the UE may receive the second channel from the base station, based on the DCI received in operation 1120.

Although not illustrated in FIG. 11, the UE may transmit, to the base station, uplink control information (UCI) with respect to both the at least one first resource region and the second resource region. In addition, the UE may transmit the UCI to the base station with respect to at least one of the first resource region and each of the second resource regions. In an embodiment of the disclosure, the UCI is transmitted via a PUCCH, and may include acknowledgement/negative acknowledgement or not acknowledged (ACK/NACK), a scheduling request (SR), channel state information (CSI), or the like.

According to an embodiment of the disclosure, an overlapping resource allocation method enables the base station and the UE to perform communication by efficiently utilizing radio resources, as a control channel and/or a reference signal and a data channel are allocated to a radio resource region in an overlapping manner.

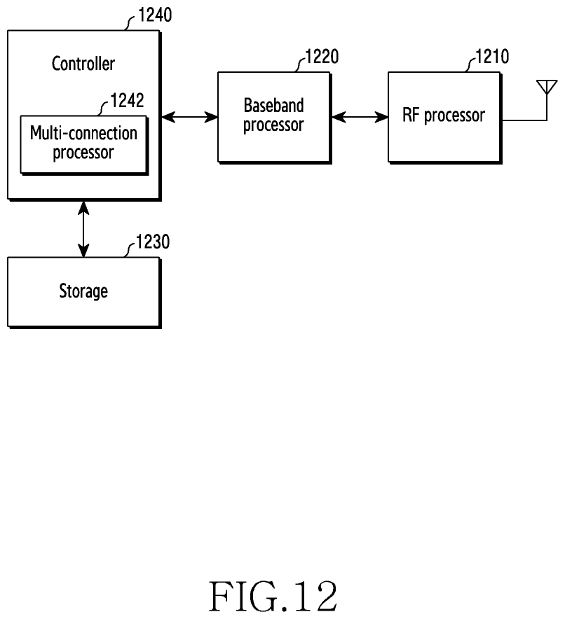

FIG. 12 is a block diagram illustrating an internal structure of a UE according to an embodiment of the disclosure.

Referring to FIG. 12, the UE may include a radio frequency (RF) processor 1210, a baseband processor 1220, a storage 1230, and a controller 1240.

The RF processor 1210 may perform a function for transmitting and receiving a signal via a wireless channel, such as band conversion and amplification of the signal. For example, the RF processor 1210 may up-convert a baseband signal provided from the baseband processor 1220 to an RF band signal, may transmit the same through an antenna, and may down-convert an RF band signal received through the antenna to a baseband signal. For example, the RF processor 1210 may include a transmission filter, a reception filter, an amplifier, a mixer, an oscillator, a digital-to-analog converter (DAC), an analog-to-digital converter (ADC), and the like. Although only one antenna is illustrated in FIG. 12, the UE may include multiple antennas. In addition, the RF processor 1210 may include multiple RF chains. Furthermore, the RF processor 1210 may perform beamforming. For the beamforming, the RF processor 1210 may adjust the phase and magnitude of each of signals transmitted and received through multiple antennas or antenna elements. In addition, the RF processing unit 1210 may perform multi-input multi-output (MIMO), and may receive multiple layers when performing a MIMO operation.

The baseband processor 1220 may perform functions of conversion between baseband signals and bitstrings according to the system's physical layer specifications. For example, during data transmission, the baseband processing 1220 may encode and modulate a transmitted bitstring to generate complex symbols. In addition, during data reception, the baseband processor 1220 may demodulate and decode a baseband signal provided from the RF processor 1210 to restore a received bitstring. For example, when following the orthogonal frequency division multiplexing (OFDM) scheme, during data transmission, the baseband processor 1220 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 1220 may split a baseband signal provided from the RF processor 1210 at the OFDM symbol level, may restore signals mapped to subcarriers through a fast Fourier transform (FFT) operation, and may restore a received bitstring through demodulation and decoding.

The baseband processor 1220 and the RF processor 1210 may transmit and receive signals as described above. Therefore, the baseband processor 1220 and the RF processor 1210 may be referred to as a transmitter, a receiver, a transceiver, or a communication unit. Furthermore, at least one of the baseband processor 1220 and the RF processor 1210 may include multiple communication modules to support multiple different radio access technologies. In addition, at least one of the baseband processor 1220 and the RF processor 1210 may include different communication modules to process signals in different frequency bands. For example, the different radio access technologies may include a wireless local area network (LAN) (e.g., Institute of Electrical and Electronics Engineers (IEEE) 802.11), a cellular network (e.g., long term evolution (LTE)), and the like. In addition, the different frequency bands may include super high frequency (SHF) (e.g., 2 NRHz) bands and millimeter wave (mmWave) (e.g., 60 GHZ) bands. The UE may transmit/receive signals to/from the base station by using the baseband processor 1220 and the RF processor1210. The signals may include control information and data.

The storage 1230 stores basic programs, application programs, and data, such as configuration information, for operation of the main base station. More particularly, the storage 1230 may store information regarding a second access node configured to perform wireless communication by using a second radio access technology. In addition, the storage 1230 provides the stored data at the request of the controller 1240.

The controller 1240 controls the overall operation of the UE. For example, the controller 1240 may transmit/receive signals through the baseband processor 1220 and the RF processor 1210. In addition, the controller 1240 records data in the storage 1230 and reads the data from the storage 1230. To this end, the controller 1240 may include at least one processor. For example, the controller 1240 may include a communication processor (CP) configured to perform control for communication, and an application processor (AP) configured to control upper layers, such as application programs. In an embodiment of the disclosure, the controller 1240 may include a multi-connection processor 1242 for processing multiple connections.

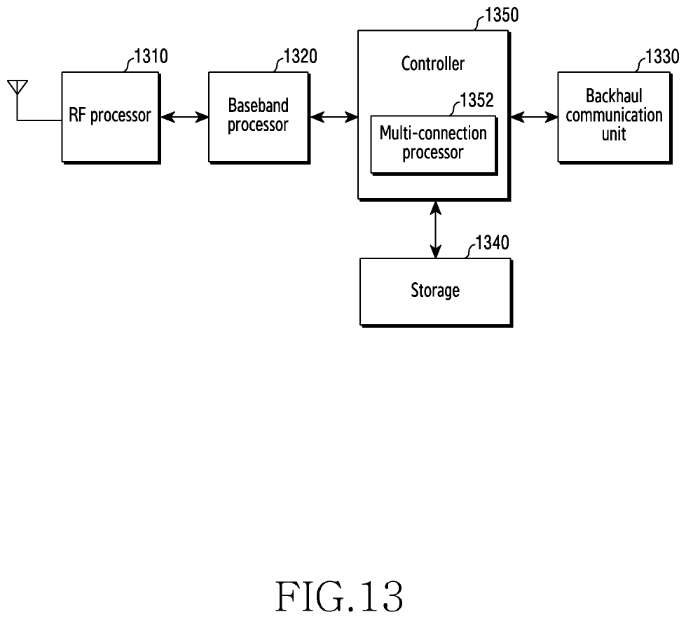

FIG. 13 is a block diagram illustrating a structure of a base station according to an embodiment of the disclosure.

Referring to FIG. 13, the base station may include an RF processor 1310, a baseband processor 1320, a backhaul communication unit 1330, a storage 1340, and a controller 1350.

The RF processor 1310 may perform a function for transmitting and receiving a signal via a wireless channel, such as band conversion and amplification of the signal. For example, the RF processor 1310 may up-convert a baseband signal provided from the baseband processor 1320 to an RF band signal, may transmit the same through an antenna, and may down-convert an RF band signal received through the antenna to a baseband signal. For example, the RF processor 1310 may include a transmission filter, a reception filter, an amplifier, a mixer, an oscillator, a DAC, and an ADC. Although only one antenna is illustrated in FIG. 13, the base station may include multiple antennas. In addition, the RF processor 1310 may include multiple RF chains. Furthermore, the RF processor 1310 may perform beamforming. For the beamforming, the RF processor 1310 may adjust the phase and magnitude of each of signals transmitted and received through multiple antennas or antenna elements. The RF processor 1310 may transmit one or more layers to perform a downward MIMO operation.

The baseband processor 1320 may perform functions of conversion between baseband signals and bitstrings according to the physical layer specifications of first radio access technology. For example, during data transmission, the baseband processor 1320 may encode and modulate a transmitted bitstring to generate complex symbols. In addition, during data reception, the baseband processor 1320 may demodulate and decode a baseband signal provided from the RF processor 1310 to restore a received bitstring. For example, when following the OFDM scheme, during data transmission, the baseband processor 1320 may encode and modulate a transmitted bitstring to generate complex symbols, may map the complex symbols to subcarriers, and may configure OFDM symbols through an IFFT operation and CP insertion. In addition, during data reception, the baseband processor 1320 may divide the baseband signal provided from the RF processor 1310 into units of OFDM symbols, restore signals mapped to subcarriers via the FFT operation, and then restore a received bit stream via demodulation and decoding. The baseband processor 1320 and the RF processor 1310 may transmit and receive signals as described above. Therefore, the baseband processor 1320 and the RF processor 1310 may be referred to as a transmitter, a receiver, a transceiver, a communication unit, or a wireless communication unit. The base station may transmit/receive signals to/from UEs by using the baseband processor 1320 and the RF processor 1310. The signals may include control information and data.

The backhaul communication unit 1330 provides an interface for performing communication with other nodes in the network. For example, the backhaul communication unit 1330 may convert bitstrings transmitted from the main base station to other nodes (for example, auxiliary base station, core network) to physical signals, and may convert physical signals received from the other nodes to bitstrings.

The storage 1340 may store basic programs, application programs, and data, such as configuration information, for operation of the main base station. More particularly, the storage 1340 may store information regarding a bearer allocated to a connected UE, a measurement result reported from the connected UE, and the like. In addition, the storage 1340 may store information serving as a criterion to determine whether to provide multi-connection to a UE or to suspend the same. In addition, the storage 1340 provides the stored data at the request of the controller 1350.

The controller 1350 controls the overall operation of the base station. For example, the controller 1350 may transmit/receive signals through the baseband processor 1320 and the RF processor 1310 or through the backhaul communication unit 1330. In addition, the controller 1350 records data in the storage 1340 and reads the data from the storage 1340. To this end, the controller 1350 may include at least one processor. In an embodiment of the disclosure, the controller 1350 may include a multi-connection processor 1352 for processing multiple connections.

In an embodiment of the disclosure, a method performed by a base station in a wireless communication system may include transmitting, to a terminal, configuration information including information on at least one first resource region to which at least one of a first channel and a first signal is allocated, transmitting, to the terminal, at least one piece of downlink control information (DCI) for scheduling transmission of a second channel, and receiving the second channel from the terminal, wherein the second channel is scheduled while being overlapped with the at least one first resource region and a second resource region, which is a remaining resource excluding the first resource region.

In an embodiment of the disclosure, at least one transport block (TB) may be allocated, in a single slot, to the at least one first resource region and the second resource region, and a modulation and coding scheme (MCS) may be individually applied to the at least one TB.

In an embodiment of the disclosure, the at least one TB may be allocated, in the single slot, to the terminal.

In an embodiment of the disclosure, the at least one TB may be allocated, in the single slot, to different terminals.

In an embodiment of the disclosure, the transmitting of the at least one piece of downlink control information to the terminal may include transmitting the at least one piece of downlink control information for scheduling transmission of the second channel with respect to both the at least one first resource region and the second resource region.

In an embodiment of the disclosure, the transmitting of the at least one piece of downlink control information to the terminal may include transmitting the at least one piece of downlink control information for scheduling transmission of the second channel with respect to each of the at least one first resource region and the second resource region.

In an embodiment of the disclosure, the method may further include receiving uplink control information (UCI) from the terminal with respect to both the at least one first resource region and the second resource region.

In an embodiment of the disclosure, the method may further include receiving uplink control information (UCI) from the terminal with respect to each of the at least one first resource region and the second resource region.

In an embodiment of the disclosure, a method performed by a terminal in a wireless communication system may include receiving, from a base station, configuration information including information on at least one first resource region to which at least one of a first channel and a first signal is allocated, receiving, from the base station, at least one piece of downlink control information (DCI) for scheduling transmission of a second channel, and transmitting the second channel to the base station, wherein the second channel is scheduled while being overlapped with the at least one first resource region and a second resource region, which is a remaining resource excluding the first resource region.

In an embodiment of the disclosure, at least one transport block (TB) may be allocated, in a single slot, to the at least one first resource region and the second resource region, and a modulation and coding scheme (MCS) may be individually applied to the at least one TB.

In an embodiment of the disclosure, a base station in a wireless communication system may include a transceiver, and at least one processor, wherein the at least one processor is configured to transmit, to a terminal, configuration information including information on at least one first resource region to which at least one of a first channel and a first signal is allocated, transmit, to the terminal, at least one piece of downlink control information (DCI) for scheduling transmission of a second channel, and receive the second channel from the terminal, wherein the second channel is scheduled while being overlapped with the at least one first resource region and a second resource region, which is a remaining resource excluding the first resource region.

In an embodiment of the disclosure, at least one transport block (TB) may be allocated, in a single slot, to the at least one first resource region and the second resource region, and a modulation and coding scheme (MCS) may be individually applied to the at least one TB.

In an embodiment of the disclosure, the at least one TB may be allocated, in the single slot, to the terminal.

In an embodiment of the disclosure, the at least one TB may be allocated, in the single slot, to different terminals.

In an embodiment of the disclosure, the at least one processor may be configured to transmit the at least one piece of downlink control information for scheduling transmission of the second channel with respect to both the at least one first resource region and the second resource region.

In an embodiment of the disclosure, the at least one processor may be configured to transmit the at least one piece of downlink control information for scheduling transmission of the second channel with respect to each of the at least one first resource region and the second resource region.

In an embodiment of the disclosure, the at least one processor may be configured to receive uplink control information (UCI) from the terminal with respect to both the at least one first resource region and the second resource region.

In an embodiment of the disclosure, the at least one processor may be configured to receive uplink control information (UCI) from the terminal with respect to each of the at least one first resource region and the second resource region.

In an embodiment of the disclosure, a terminal in a wireless communication system may include a transceiver, and at least one processor, wherein the at least one processor is configured to receive, from a base station, configuration information including information on at least one first resource region to which at least one of a first channel and a first signal is allocated, receive, from the base station, at least one piece of downlink control information (DCI) for scheduling transmission of a second channel, and transmit the second channel to the base station, wherein the second channel is scheduled while being overlapped with the at least one first resource region and a second resource region, which is a remaining resource excluding the first resource region.

In an embodiment of the disclosure, at least one transport block (TB) may be allocated, in a single slot, to the at least one first resource region and the second resource region, and a modulation and coding scheme (MCS) may be individually applied to the at least one TB.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks, such as the Internet, Intranet, local area network (LAN), wide LAN (WLAN), and storage area network (SAN) or a combination thereof. Such a storage device may access the electronic device via an external port. In addition, a separate storage device on the communication network may access a portable electronic device.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a base station in a wireless communication system, the method comprising:
transmitting, to a terminal, configuration information including information on at least one first resource region to which at least one of a first channel and a first signal is allocated;
transmitting, to the terminal, at least one piece of downlink control information (DCI) for scheduling transmission of a second channel; and
receiving the second channel from the terminal,
wherein the second channel is scheduled to overlap with the at least one first resource region and a second resource region corresponding to resources other than the first resource region.

2. The method of claim 1,
wherein, in one slot, at least one transport block (TB) is allocated to the at least one first resource region and the second resource region, and
wherein a modulation and coding scheme (MCS) is individually applied to the at least one TB.

3. The method of claim 2, wherein, in the one slot, the at least one TB is allocated to the terminal or to different terminals.

4. The method of claim 1, wherein the transmitting of the at least one piece of DCI to the terminal comprises transmitting the at least one piece of DCI for scheduling transmission of the second channel in both or each of the at least one first resource region and the second resource region.

5. The method of claim 1, further comprising:
receiving uplink control information (UCI) from the terminal in both or each of the at least one first resource region and the second resource region.

6. A method performed by a terminal in a wireless communication system, the method comprising:
receiving, from a base station, configuration information including information on at least one first resource region to which at least one of a first channel and a first signal is allocated;
receiving, from the base station, at least one piece of downlink control information (DCI) for scheduling transmission of a second channel; and
transmitting the second channel to the base station,
wherein the second channel is scheduled to overlap with the at least one first resource region and a second resource region corresponding to resources other than the first resource region.

7. The method of claim 6,
wherein, in one slot, at least one transport block (TB) is allocated to the at least one first resource region and the second resource region, and
wherein a modulation and coding scheme (MCS) is individually applied to the at least one TB.

8. A base station in a wireless communication system, the base station comprising:
a transceiver;
memory, comprising one or more storage media, storing instructions; and
at least one processor communicatively coupled to the transceiver and the memory,
wherein the instructions, when executed by the at least one processor individually or collectively, cause the at least one processor to:
transmit, to a terminal, configuration information including information on at least one first resource region to which at least one of a first channel and a first signal is allocated,
transmit, to the terminal, at least one piece of downlink control information (DCI) for scheduling transmission of a second channel, and
receive the second channel from the terminal, and
wherein the second channel is scheduled to overlap with the at least one first resource region and a second resource region corresponding to resources other than the first resource region.

9. The base station of claim 8,
wherein, in one slot, at least one transport block (TB) is allocated to the at least one first resource region and the second resource region, and
wherein a modulation and coding scheme (MCS) is individually applied to the at least one TB.

10. The base station of claim 9, wherein, in the one slot, the at least one TB is allocated to the terminal or to different terminals.

11. The base station of claim 8, wherein the instructions, when executed by the at least one processor individually or collectively, further cause the base station to transmit the at least one piece of DCI for scheduling transmission of the second channel in both or each of the at least one first resource region and the second resource region.

12. The base station of claim 8, wherein the instructions, when executed by the at least one processor individually or collectively, further cause the base station to receive uplink control information (UCI) from the terminal in both or each of the at least one first resource region and the second resource region.

13. A terminal in a wireless communication system, the terminal comprising:
a transceiver;
memory, comprising one or more storage media, storing instructions; and
at least one processor communicatively coupled to the transceiver and the memory,
wherein the instructions, when executed by the at least one processor individually or collectively, cause the at least one processor to:
receive, from a base station, configuration information including information on at least one first resource region to which at least one of a first channel and a first signal is allocated,
receive, from the base station, at least one piece of downlink control information (DCI) for scheduling transmission of a second channel, and
transmit the second channel to the base station, and
wherein the second channel is scheduled to overlap with the at least one first resource region and a second resource region corresponding to resources other than the first resource region.

14. The terminal of claim 13,
wherein, in one slot, at least one transport block (TB) is allocated to the at least one first resource region and the second resource region, and
wherein a modulation and coding scheme (MCS) is individually applied to the at least one TB.

15. One or more non-transitory computer-readable storage media storing one or more computer programs including computer-executable instructions that, when executed by one or more processors of a base station in a wireless communication system individually or collectively, cause the base station to perform operations, the operations comprising:
transmitting, to a terminal, configuration information including information on at least one first resource region to which at least one of a first channel and a first signal is allocated;
transmitting, to the terminal, at least one piece of downlink control information (DCI) for scheduling transmission of a second channel; and
receiving the second channel from the terminal,
wherein the second channel is scheduled to overlap with the at least one first resource region and a second resource region corresponding to resources other than the first resource region.

16. The one or more non-transitory computer-readable storage media of claim 15,
wherein, in one slot, at least one transport block (TB) is allocated to the at least one first resource region and the second resource region, and
wherein a modulation and coding scheme (MCS) is individually applied to the at least one TB.

17. The one or more non-transitory computer-readable storage media of claim 16, wherein, in the one slot, the at least one TB is allocated to the terminal or to different terminals.

18. The one or more non-transitory computer-readable storage media of claim 15, wherein the transmitting of the at least one piece of DCI to the terminal comprises transmitting the at least one piece of DCI for scheduling transmission of the second channel in both or each of the at least one first resource region and the second resource region.

19. The one or more non-transitory computer-readable storage media of claim 15, the operations further comprising:
receiving uplink control information (UCI) from the terminal in both or each of the at least one first resource region and the second resource region.
